(19) United States
(12) Patent Application Publication
(10) Pub. No.: US 2025/0104951 A1
(43) Pub. Date: Mar. 27, 2025

(54) SWITCH CHAMBER FOR AN ELECTRICAL SWITCH

(71) Applicant: Siemens Aktiengesellschaft, München (DE)

(72) Inventors: Jürgen Kummer, Amberg (DE); Petra Schneider, Freudenberg (DE); Thomas Sperl, Schmidgaden (DE)

(21) Appl. No.: 18/892,797

(22) Filed: Sep. 23, 2024

(30) Foreign Application Priority Data
Sep. 22, 2023 (DE) 10 2023 209 301.4

(51) Int. Cl. H01H 71/02

(52) U.S. Cl. CPC H01H 71/025

(57) ABSTRACT

A switch chamber for an electrical switch has electrical contacts for switching a current within a switch chamber. The switch chamber has at least one outlet and a swirl chamber arranged at the outlet of the switch chamber. The swirl chamber has a complex geometry that enables a filter function without additional filter elements.

### CROSS-REFERENCE TO RELATED APPLICATION

This application claims the priority, under 35 U.S.C. § 119, of German Patent Application DE 10 2023 209 301.4, filed Sep. 22, 2023; the prior application is herewith incorporated by reference in its entirety.

### FIELD AND BACKGROUND OF THE INVENTION

The present invention relates to a switch chamber for an electrical switch.

Current-limiting switching devices, in particular current-limiting circuit breakers, for example in the form of MCCBs (Molded Case Circuit Breakers), are typically used in widely branched power distribution networks. It is common practice to operate selective staggering with a minimum rated current distance between the switching devices involved. Depending on the connected loads, each branching level can be protected against overloads and short circuits with an appropriately dimensioned switching device.

For example, a switching device that is arranged closest to a load and is often referred to as a load-proximal switching device, a switching device close to the load or downstream is designed for the lowest rated current. If a short-circuit current now flows both through the switching device close to the load and through a switching device that is arranged above the switching device close to the load in the hierarchy of the power distribution network and is often referred to as a load-distal switching device, a remote or upstream switching device, only the load-proximal switching device that is close to the load should switch off. In other words, in the event of a fault (short circuit), only the switching device closest to the event should interrupt the current flow.

The switching contact pairs of the switching device close to the load and the switching device remote from the load draw an arc when opening, wherein the opening width of the switching contact pairs and also the arc energy are higher for the load-proximal switching device close to the load due to the lower mass moment of inertia of its moving current path including the switching contacts. This possibly only single-pole opening must be followed by an all-pole disconnection of the switching device close to the load. The load-distal switching device remote from the load must not switch off, so as not to disconnect other loads from the power distribution network. However, the switching device remote from the load may have a supporting effect by briefly lifting the switching contacts, i.e., may contribute to switching off the switching device close to the load by limiting the current, for example.

Switching devices that act in such a staggered manner in power distribution networks behave selectively. In order to achieve this selectivity, it is necessary for the switching devices closest to the fault to interrupt the current paths of all switching poles faster than the higher-level switching devices.

U.S. Pat. No. 5,103,198 (DE 691 10 540 T2) and U.S. Pat. No. 5,298,874 (DE 692 17 441 T2) disclose electrical switching arrangements in the form of circuit breakers with insulating material housings, which comprise two switching contacts per switching pole that are resiliently pressed against each other in the closed position of the circuit breaker. The switching contacts can be separated by the effect of electrodynamic recoil forces if the current flowing through the switching contacts exceeds a certain threshold value in order to limit said current.

The circuit breaker disclosed in the publications comprises an overload and/or short-circuit detection element for energizing a switch-off mechanism which causes the circuit breaker to disconnect automatically in the event of a fault. Further, the circuit breaker disclosed in the publications comprises an actuator which responds to an excess pressure generated in the separation zone of said switching contacts by an arc drawn by electrodynamic recoil of the switching contacts to actuate the switch-off mechanism of the circuit breaker.

Further pressure releases, or pressure trip units, are disclosed in the following publications: US 2012/0026638 A1 (DE 10 2009 015 126 A1), US 2012/0314331 A1 (DE 10 2011 077 359 A1) and US 2019/0043679 A1 (DE 10 2018 211 995 B4).

The electric arc when the switching contact pairs are opened causes the gas to ionize and form a plasma. The plasma generates contaminants, for example through the burn-off of the switching contacts, which may be deposited in the switch chamber of the electrical switch, but also in the downstream pressure release, and may lead to a malfunction of the same. Contamination of the downstream assemblies due to contact material burn-off during overload or short-circuit disconnection prevents the reliable operation of an electrical switch.

### SUMMARY OF THE INVENTION

It is therefore the object of the invention to provide a switch chamber that makes it possible to prevent contamination of the subsequent or downstream assemblies.

With the above and other objects in view there is provided, in accordance with the invention, a switch chamber for an electrical switch, the switch chamber comprising:
electrical contacts for connecting a current within an opening section;
the switch chamber being formed with at least one outlet and a swirl chamber formed at said at least one outlet.

In other words, the objects of the invention are achieved with a switch chamber for an electrical switch that comprises electrical contacts for switching a current within the switch chamber, wherein at least one outlet is arranged at the switch chamber and a swirl chamber is arranged at the outlet of the switch chamber.

The advantage here is that, using the switch chamber with a swirl chamber according to the invention, a filter function can be realized without additional filter elements. This saves on components, reduces costs as fewer parts need to be assembled, ensures that contaminants are retained in a defined area and guarantees better functioning of the downstream contamination-reduced assemblies.

In one embodiment of the switch chamber according to the invention, the swirl chamber has a gas inlet which is fluidically connected to the outlet of the switch chamber.

In a further embodiment of the switch chamber according to the invention, the swirl chamber fulfills a filter function by means of a complex geometry without additional filter elements.

In a further embodiment of the switch chamber according to the invention, the swirl chamber with complex geometry has the shape of a semi-ellipsoid or a cone.

In a further embodiment of the switch chamber according to the invention, the geometry of the swirl chamber is divided into a swirl zone and lateral calming zones. The lateral calming zones serve to collect contamination.

In a further embodiment, the gas inlet into the swirl chamber is arranged off-center to the swirl chamber.

In a further embodiment of the switch chamber according to the invention, the outlet from the swirl chamber is arranged at the end of the swirl zone with the smallest radius.

In a further embodiment, the outlet from the swirl chamber leads directly or indirectly into a pressure release for detecting a triggering of the electrical switch via the pressure increase.

In a further embodiment of the switch chamber according to the invention, the swirl chamber is part of the switch chamber. The swirl chamber can be formed in the housing wall of the switch chamber. Alternatively, the swirl chamber is a separate component which is mounted on the switch chamber.

Other features which are considered as characteristic for the invention are set forth in the appended claims.

Although the invention is illustrated and described herein as embodied in a switch chamber for an electrical switch, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic view of an electrical switch with a switch chamber and electrical contacts in the switch chamber;

FIGS. 2A and 2B are partial perspective views of a portion of a switch chamber with a prior art solution for reducing the escape of contaminants at the outlet of the switch chamber;

FIGS. 3A and 3B are partial perspective views of a portion of a switch chamber with a further prior art solution for reducing the escape of contaminants at the outlet of the switch chamber;

FIGS. 4A and 4B show different views of the switch chamber with swirl chamber according to the invention;

FIGS. 5A and 5B show different sectional planes through the switch chamber with swirl chamber according to the invention; and

FIGS. 6A and 6B show further different sectional views of the switch chamber according to the invention.

### DETAILED DESCRIPTION OF THE INVENTION

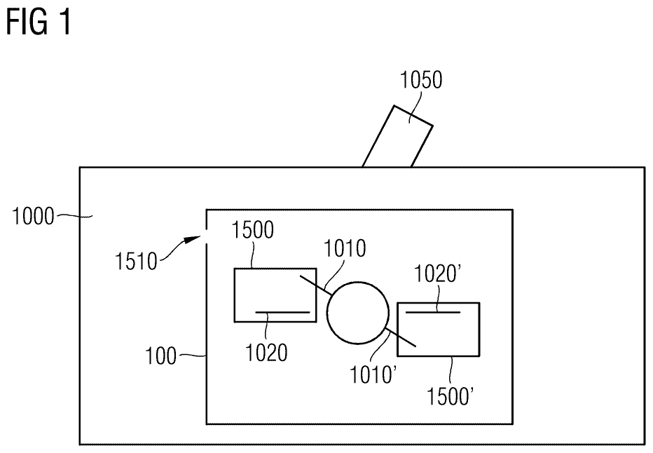

FIG. 1 shows an electrical switch 1000 with a switch chamber 100. The switch chamber 100 contains electrical contacts 1010; 1020 or 1010′; 1020′ for connecting a current within an opening section 1500; 1500′. FIG. 1 shows a double interrupter with two contact pairs 1010; 1020 and 1010′; 1020′ as well as two opening sections 1500; 1500′. Likewise, the switch chamber 100 may contain (at least) one pair of electrical contacts 1010; 1020 and (at least) one opening section 1500.

The switch chamber 100 has an outlet 1510 so that a pressure increase can be transmitted from the switch chamber 100 through this outlet 1510 to a pressure release or pressure trip unit.

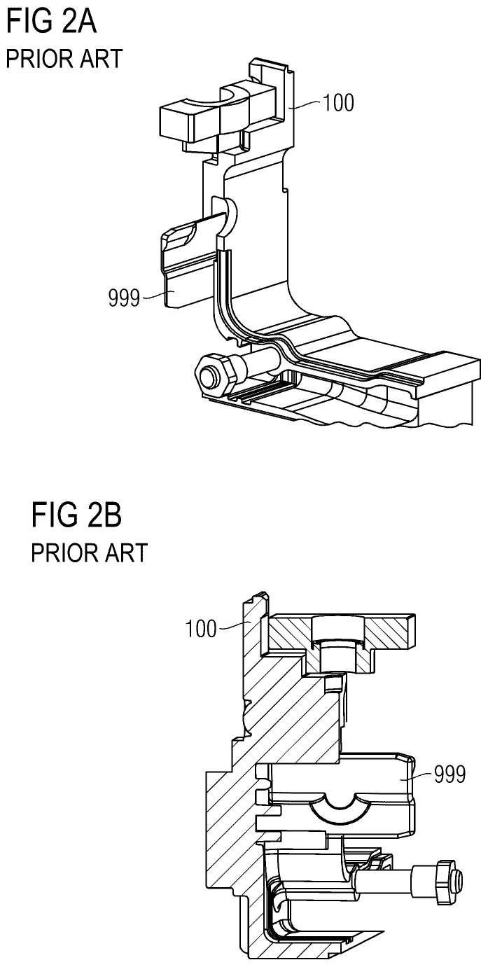

FIGS. 2A and 2B show a detail of a switch chamber 100, wherein an additional component 999 is provided which guides the flow so that contaminants cannot enter the downstream assembly directly.

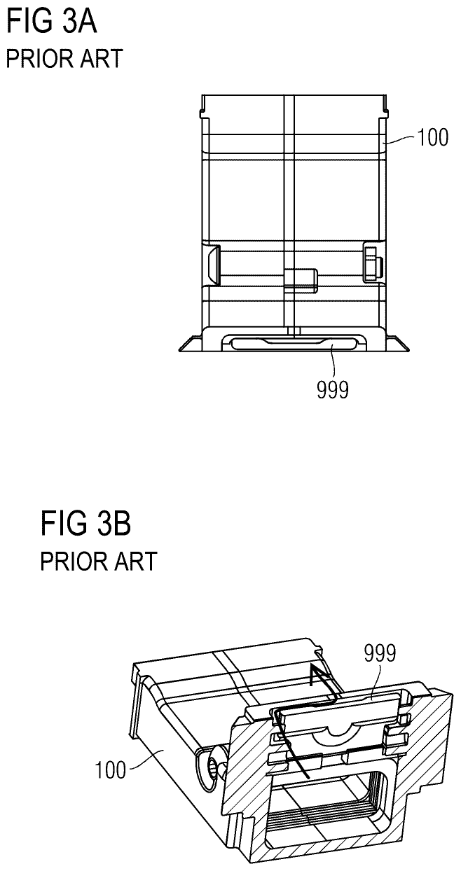

FIGS. 3A and 3B also show parts of the switch chamber 100 and the additional component 999. FIG. 3B shows the flow path along the additional component 999; due to the labyrinth-like routing of the gases, deposits of contaminants will be produced. This principle needs to be improved.

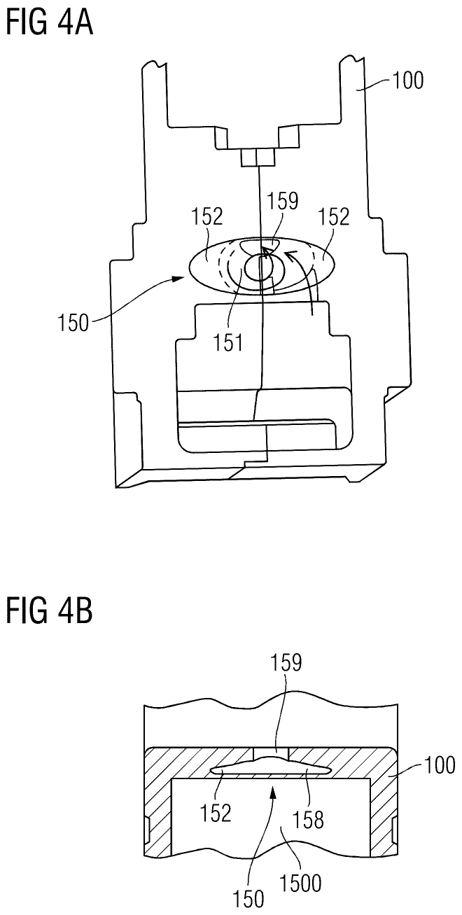

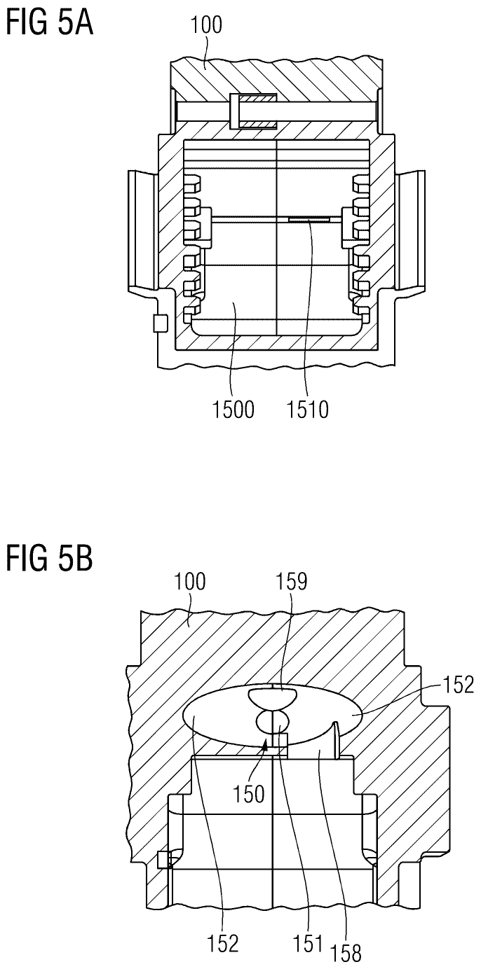

FIG. 4A shows the switch chamber 100 of an electrical switch 1000 according to the invention. A swirl chamber 150 is arranged at the outlet 1510 of the switch chamber 100 (FIGS. 1 and 5A) for this purpose. The swirl chamber 150 has a gas inlet 158, which is fluidically connected to the outlet 1510 of the switch chamber 100.

The swirl chamber 150 fulfills a filter function through a complex geometry without additional filter elements. The swirl chamber 150, for this purpose, has a complex geometry in the shape of a semi-ellipsoid or a cone.

The geometry of the swirl chamber 150 is divided into a swirl zone 151 and lateral calming zones 152. These lateral calming zones 152 serve to collect contaminants.

FIG. 4B shows another view of the switch chamber 100 according to the invention. The gas enters the swirl chamber 150 from the switch chamber 100 through the gas inlet 158. The swirl chamber 150 has a swirl zone 151 and lateral calming zones 152. The gas inlet 158 into the swirl chamber 150 is arranged eccentrically to the swirl chamber 150.

The outlet 159 from the swirl chamber 150 is located at the end of the swirl zone 151 with the smallest radius.

FIGS. 5A and 5B show the switch chamber 100 according to the invention in different sectional views. FIG. 5A shows the switch chamber 100 with the opening section 1500 and its outlet 1510 into the swirl chamber 150.

The further sectional view of FIG. 5B shows the gas inlet 158 into the swirl chamber 150, as well as the swirl zone 151 and the lateral calming zones 152. The outlet 159 from the swirl chamber 150 is located at the end of the swirl zone 151 with the smallest radius.

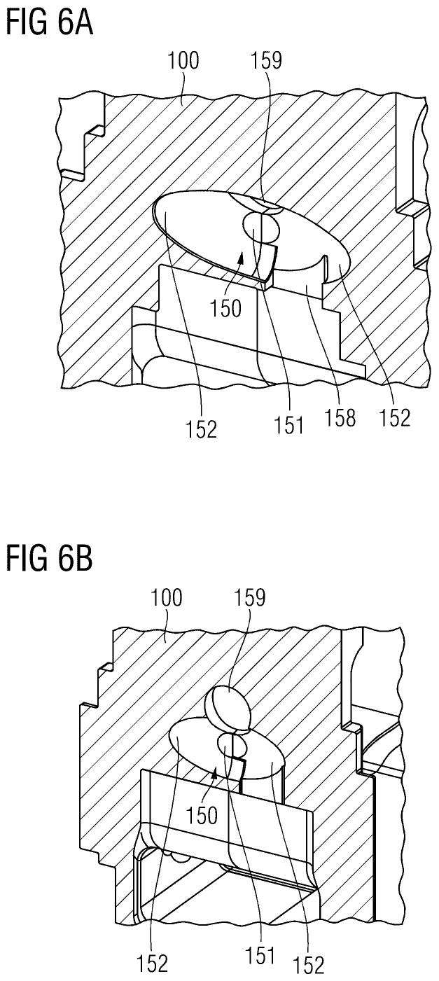

FIGS. 6A and 6B show further sectional views of the switch chamber 100 according to the invention. FIG. 6A shows the gas inlet 158, which is arranged off-center to the swirl chamber 150. FIG. 6A also shows the switch chamber 100 according to the invention with swirl chamber 150 and swirl zone 151 and lateral calming zones 152.

FIG. 6B again shows the swirl chamber 150 with its outlet 159. A pressure release for detecting a triggering of the electrical switch 1000 via the pressure increase can be arranged directly or indirectly at the outlet 159 from the swirl chamber 150.

As shown in FIGS. 4A, 4B, 5A, 5B, 6A and 6B, the swirl chamber 150 can be part of the switch chamber 100. For example, the swirl chamber 150 can be formed in the housing wall of the switch chamber 100.

Alternatively, the swirl chamber 150 can be a separate component mounted on the switch chamber 100.

During the overload and/or short-circuit disconnection, exhaust gases are produced, the exhaust gas flow of which causes contaminants inside the switch chamber 100. Due to the swirl chamber 150 between the switch chamber 100 and the downstream assembly according to the invention, the contaminants remain in the swirl chamber 150. For example, the contaminants can be deposited in the lateral calming zones 152, which prevents them from escaping from the outlet 159 of the swirl chamber 150.

The switch chamber 100 according to the invention fulfills a filter function by means of a complex geometry in a component without additional filter elements. The complex geometry has the shape of a semi-ellipsoid or a cone, for example. This geometry is divided into swirl zone 151 and lateral calming zones 152. The calming zones 152 are used to absorb the contamination. The gas inlet 158 into the swirl chamber 150 should be formed eccentrically in the swirl chamber 150. The outlet 159 from the swirl chamber 150 is at the end of the swirl zone 151 with the smallest radius.

The primary advantage of the invention is a savings in terms of components, a savings in terms of costs due to the saving of parts and assembly costs, the retention of contamination in a defined area, and better functionality of the downstream contamination-reduced assemblies.

1. A switch chamber for an electrical switch, the switch chamber comprising:
electrical contacts for connecting a current within an opening section;
the switch chamber being formed with at least one outlet and a swirl chamber formed at said at least one outlet.

2. The switch chamber according to claim 1, wherein said swirl chamber is formed with a gas inlet fluidically connected to said at least one outlet of the switch chamber.

3. The switch chamber according to claim 1, wherein said swirl chamber is configured to fulfill a filter function by means of a complex geometry thereof without additional filter elements.

4. The switch chamber according to claim 1, wherein said swirl chamber with complex geometry has a shape of a semi-ellipsoid or of a cone.

5. The switch chamber according to claim 1, wherein a geometry of said swirl chamber is divided into a swirl zone and lateral calming zones.

6. The switch chamber according to claim 5, wherein said calming zones are configured to absorb contaminants.

7. The switch chamber according to claim 1, which comprises a gas inlet into said swirl chamber and arranged eccentrically relative to said swirl chamber.

8. The switch chamber according to claim 1, which comprises an outlet from said swirl chamber arranged at an end of said swirl zone having a smallest radius.

9. The switch chamber according to claim 8, wherein said outlet from said swirl chamber leads directly or indirectly into a pressure release for detecting a triggering of the electrical switch via a pressure increase.

10. The switch chamber according to claim 1, wherein said swirl chamber forms a part of the switch chamber.

11. The switch chamber according to claim 10, wherein said swirl chamber is formed in a housing wall of the switch chamber.

12. The switch chamber according to claim 1, wherein said swirl chamber is a separate component mounted on the switch chamber.
